(19) United States
(12) Patent Application Publication
(10) Pub. No.: US 2010/0226398 A1
(43) Pub. Date: Sep. 9, 2010

(54) Systems and Methods for Upgrading Non-Compliant Laser Devices

(75) Inventors: Joseph Raymond Bentley, West Jordan, UT (US); Bruce Walker, Syracuse, UT (US); Xiao Pei Tao, Shanghai (CN)

Correspondence Address: STEVEN L. NICHOLS;Van Cott, Bagley, Cornwall & McCarthy, 36 South State Street, SUITE 1900, SALT LAKE CITY, UT, 84111, US

(73) Assignee: Xiao Pei Tao, Shanghai (CN)

(21) Appl. No.: 12/400,607

(22) Filed: Mar. 9, 2009

(51) Int. Cl. H01S 3/00

(52) U.S. Cl. 372/38.03

(57) ABSTRACT

An assembly for use with a non-compliant laser device comprising the combination of an emission indicator assembly configured to indicate the actuation of the non-compliant laser device, a key control assembly configured to selectively provide electrical continuity throughout the circuitry of non-compliant laser device, and a remote interlock assembly configured to selectively provide for remote control of the non-compliant laser device and provide electrical continuity throughout the circuitry of non-compliant laser device.

### BACKGROUND

The term “laser” is an acronym for “light amplification by stimulated emission of radiation,” a phrase coined by American physicist and inventor, Gordon Gould. Lasers are well-known devices that emit light (electromagnetic radiation) through the process of stimulated emission. The laser and its many variants have been employed in thousands of highly varied applications in every sector of modem society, including consumer electronics, information technology, science, medicine, industry, law enforcement, entertainment, and the military. Lasers are used in everyday products ranging from complex surgical devices to Digital Video Disc (DVD) and Company Disc (CD) players.

In certain situations, lasers can be very dangerous to the human body. For example, even low power lasers can cause minor damage to the human eye if the beam hits the eye directly or is reflected from a shiny surface. Other lasers are powerful enough to cause immediate and severe eye damage or even bum skin.

Due to the inherent dangers of laser operation, federal and state regulations control the manufacturing and sale of products containing laser devices. In order to best regulate the sale of lasers or laser-containing devices, various different types of lasers have been classified based on those lasers' potential to do harm. The U.S. Food and Drug Administration's (FDA) Center for Devices and Radiological Health (CDRH) has provided detailed regulations in the manufacture of lasers and laser devices. These regulations, among other things, require lasers to include specific features based on such parameters as their type, class, wavelength, and power output.

By way of example, lasers have been separated into various classes. Class IIIA lasers are considered intermediate power lasers (continuous wave (CW): 1-5 mW), and are only hazardous for intrabeam viewing. Class IIIB lasers are moderate power lasers (CW: 5-500 mW, pulsed: 10 J/cm² or the diffuse reflection limit, which ever is lower). In general, Class IIIB lasers are not be a fire hazard and are not generally capable of producing a hazardous diffuse reflection except for conditions of intentional staring done at distances close to the diffuser. Finally, Class IV lasers are high power lasers (CW: 500 mW), are hazardous to view under any condition (directly or diffusely scattered) and are a potential fire hazard and a skin hazard. Significant controls are required of Class IV lasers.

Despite the detailed regulations that control the manufacture, sale and distribution of lasers and laser-containing devices, several non-compliant laser devices have been manufactured and sold in commerce. A non-compliant laser may be missing several important performance features that are required by regulation and increase the safety of such a laser device. For example, several Class IIIB lasers have been manufactured and/or sold missing three important performance features: (1) a key control; (2) a remote interlock connector; and (3) an emission indicator. Because of the vast amount of non-compliant lasers previously sold, the cost of recalling or replacing the non-compliant lasers would be extremely high.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a schematic view of a non-compliant laser device according to an embodiment of the present exemplary system and method.

FIG. 2 is a diagram of the electrical circuit of the non-compliant laser device of FIG. 1 according to an embodiment of the present exemplary system and method.

FIG. 3 is an exploded view of a non-compliant laser device incorporating compliant elements according to an embodiment of the present exemplary system and method.

FIG. 4 is a schematic view of a battery housing according to an embodiment of the present exemplary system and method.

FIG. 5 is an exploded view of an emission indicator assembly according to an embodiment of the present exemplary system and method.

FIG. 6 is an exploded view of a key control/remote interlock assembly according to an embodiment of the present exemplary system and method.

FIG. 7 is a diagram of the control circuitry of the non-compliant laser device incorporating compliant elements according to an embodiment of the present exemplary system and method.

Throughout the drawings, identical reference numbers designate similar, but not necessarily identical, elements.

### DETAILED DESCRIPTION

The present specification describes methods and material kits that allow retrofitting of a non-compliant laser device to make that laser device compliant with applicable regulations. As described herein, these methods and products are developed for use with any laser device including laser devices that differ in various aspects including, but not limited to, type, class, wavelength, and power output. In various examples, the methods and products described herein are for use in retrofitting a laser device to comply with applicable regulations.

Previously, the primary method of remedying the non-compliancy of a laser product, such as class IIIB lasers, has been to perform a post-sale recall of the lasers. Upon recall, the manufacturer of the laser device may either replace the laser with a compliant laser or somehow upgrade the previously sold laser device such that it becomes compliant with applicable regulations.

Although replacing previously sold lasers with a compliant laser device is an option, for most manufacturers, due to the number of non-compliant lasers previously sold, the cost of doing so would be enormous. Alternatively, the costs of bringing a non-compliant laser into compliancy may be considerably less by re-manufacturing the previously sold lasers. However, many of these laser devices were designed in such a way that once assembled, the working parts of the laser are not accessible except by destroying at least portions of the laser device. In fact, the only part of the laser device generally intended to be removed by the purchaser of one of these laser devices is the battery cover. Therefore, current solutions for bringing non-compliant lasers and laser devices into compliancy are not economically viable solutions.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As used herein and in the appended claims, a compliant laser device is one that satisfies the applicable health and safety regulations of a given jurisdiction, for example, the United States, European Union, Japan, China, etc. A non-compliant laser device is a device that, in at least one respect, does not satisfy the applicable health and safety regulations of a given jurisdiction.

Finally, as used herein and in the appended claims, the methods and material kits that allow retrofitting of a non-compliant laser device may be applied to any device which is capable of light amplification by stimulated emission of radiation. In other words, the methods and material kits that allow retrofitting of a non-compliant laser device may be applied to any laser device.

### Basic Laser Device

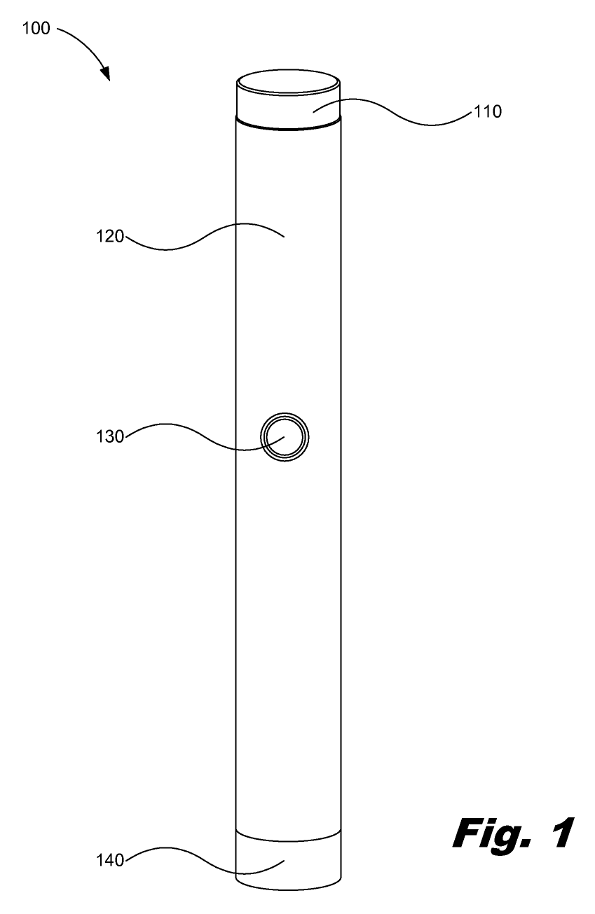

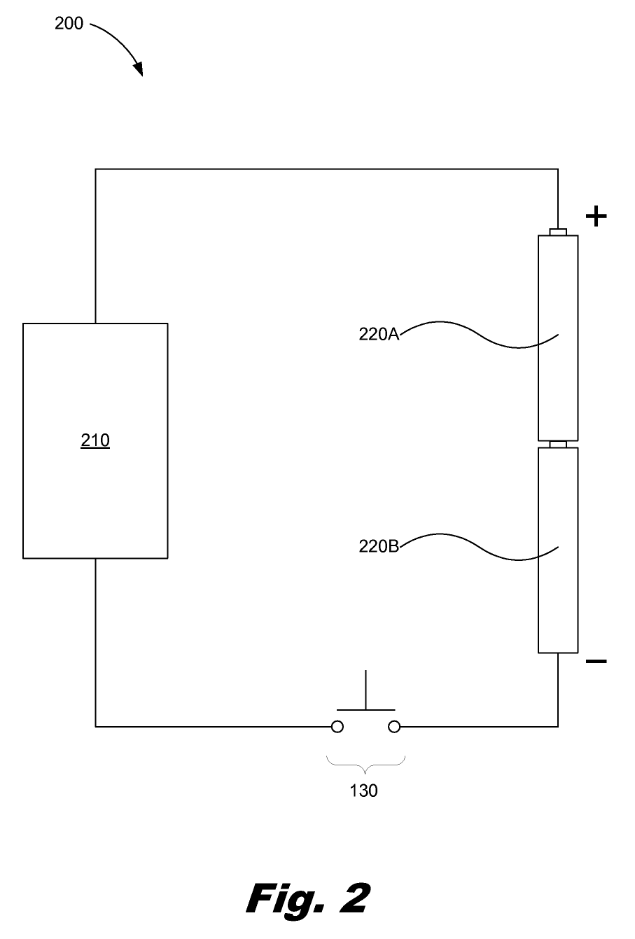

To begin, the elements of a basic laser device will now be explained. FIGS. 1 and 2 depict various elements of a basic laser device (100). Specifically, FIG. 1 is a schematic view of a basic laser device (100) according to an embodiment of the present exemplary system and method. FIG. 2 illustrates the circuit of a basic laser device. Without more, the illustrated laser device may be lacking all the components needed to be a compliant device.

Referring to FIG. 1, the basic laser device (100) may comprise a light emission end (110) which may include an aperture for allowing light to exit the device. The light emission end (110) of the laser device (100) may also include various optical devices such as one or more lenses.

Further, the laser device (100) may be contained within a cylindrical laser housing (120). The laser housing (120) of the laser device (100) may also include an electrical contact (not shown) for completing the electrical circuit between the laser device assembly which produces the laser beam, and the power source used to deliver power to the laser device assembly. In one embodiment, the power source may comprise a number of batteries as will be discussed in more detail below.

A battery cover (140) may also be included in the laser device (100) for retaining a number of batteries within the laser housing (120). The battery cover (140) may be removably engaged with the laser housing (120), and may have threads at one end configured to engage threads located within the inner wall of the laser housing (120). Like the laser housing (120), the battery cover (140) of the laser device (100) may also include an electrical contact for completing the electrical circuit between the batteries and the battery cover (140).

Finally, the illustrated laser device may include a switch (130) for completing the electrical circuit of the laser device (100), and activating the emission of light from the light emission end (110) of the laser device (100). The switch (130) may be engineered such that the user must continually hold down the switch (130) (e.g. a “momentary ‘on’ switch”) to operate the laser device (100). Alternatively, the switch (130) may be engineered such that the user presses or otherwise engages or disengages the switch (130) once and the laser device selectively turns on or off.

FIG. 2 is a diagram of a basic electrical circuit (200) of the laser device (100) of FIG. 1 according to an embodiment of the present exemplary system and method. The electrical circuit (200) may be housed within the laser housing (FIG. 1, 120). The electrical circuit (200) may comprise a laser device assembly (210), a power source (220A, 220B), and the electrical components of the switch (130).

The laser device assembly (210) may be any assembly that is capable of producing a beam of electromagnetic radiation through the process of stimulated emission of radiation, and may include elements such as a gain medium disposed within a reflective optical cavity. Further, the power source (220A, 220B) may include any source capable of providing sufficient electromotive force to activate the laser device assembly (210). In one exemplary embodiment, the power source may include a number of batteries (220A, 220B). The batteries may be any type of power cell including, but not limited to, galvanic cells, electrolytic cells, voltaic cells, and fuel cells.

### Compliant Laser Device Elements

As discussed above, a non-compliant laser device may be brought into compliance via the inclusion or addition of one or more elements that enhance the safety of the device. The incorporation of such elements into non-compliant laser device will now be disclosed.

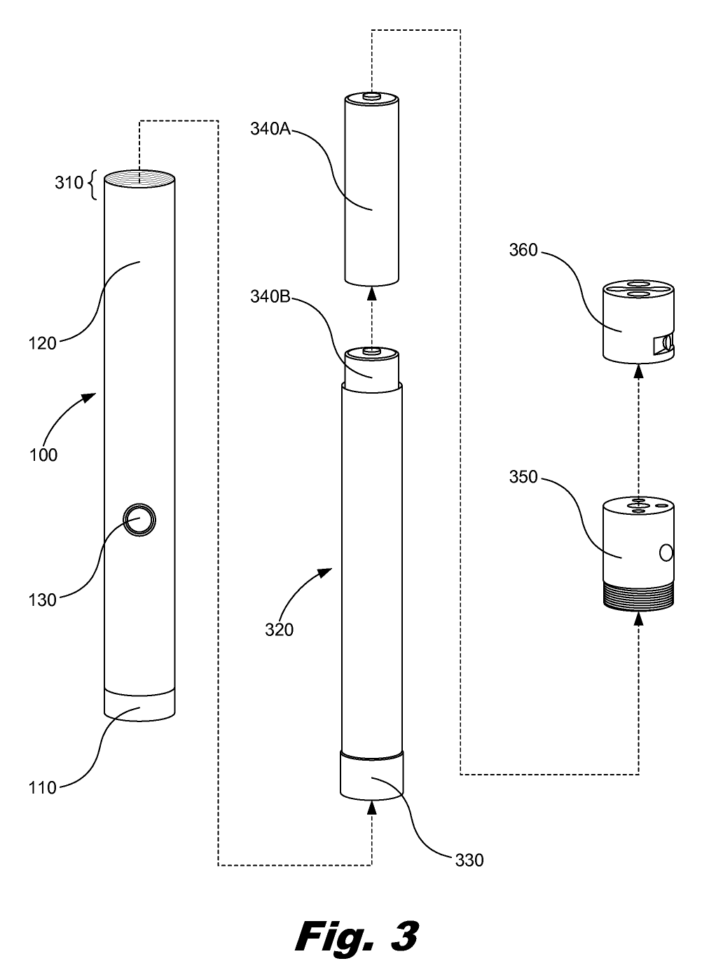

FIG. 3 is an exploded view of the non-compliant laser device (100) incorporating compliant elements according to an embodiment of the present exemplary system and method. A non-compliant laser device (100) as was discussed above may require several elements in order to be brought into compliancy. In one embodiment, a battery housing (320), appropriately sized batteries (340A, 340B), an emission indicator assembly (350), and a key control/remote interlock assembly (380) may be incorporated into the non-compliant laser device (100). FIG. 3 depicts one manner in which these elements may be arranged. However, alternative arrangements are possible and contemplated within the principles disclosed herein.

As is depicted in FIG. 3, the battery cover (FIG. 1, 140) of the non-compliant laser device (100) may be removed to expose internal threads (310) of the laser housing (FIG. 1, 120). As will be discussed in more detail below, these internal threads (310) may be configured to be removably coupled to an emission indicator assembly (350) or other element used to bring the non-compliant laser device (100) into compliancy.

As described above, a basic laser device (100) may typically include a battery housing (320). The battery housing (320) is used to retain a number of batteries in order to power the laser device (100). In some embodiments, in order to make the non-compliant laser device (100) compliant, the non-compliant laser device (100) may be provided with an emission indicator assembly (350). The emission indicator assembly (350) is used to indicate to a user that the laser device is on as will be described in more detail below.

Finally, a combination assembly of a key control and remote interlock assembly (360) may be provided. The key control/remote interlock assembly (360) may be fastened to the emission indicator assembly (350). Generally, the key control of the key control/remote interlock assembly (360) is a safety device used to selectively provide or interrupt electrical energy flow through the circuit of the laser device (100). In other words, once the key control is engaged, the electric circuit of the laser device (100) is closed, and the laser device (100) may operate. On the other hand, if the key control is disengaged, the electric circuit of the laser device (100) is open, and the laser device (100) will not operate.

The remote interlock of the key control/remote interlock assembly (360) is a safety device used to remotely control the laser device (100) with an external switch.

As described above, the key control/remote interlock assembly (360) may be embodied in one assembly. However, in another exemplary embodiment, the key control and the remote interlock assembly may be embodied in separate elements and electrically coupled.

### Battery Housing

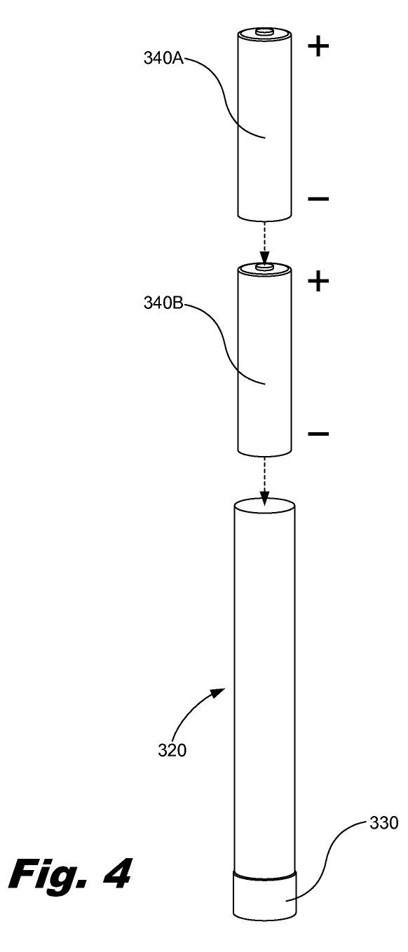

The individual compliant elements will now be discussed. To begin, FIG. 4 is a schematic view of a battery housing (320) according to an embodiment of the present exemplary system and method. The battery housing (320) may be made from any electrically conductive material. In one exemplary embodiment, the battery housing (320) may be sized to match the inside of the laser housing (FIG. 3, 120). Specifically, the battery housing (320) may have a cylindrical shape and be designed such that it securely fits within the internal bore of the laser housing (FIG. 3, 120). The internal bore of the battery housing (320) may be designed such that one or more batteries (340A, 340B) of a specific size may securely fit within the battery housing (320). The battery housing (320) may include an electrically conductive end (330) which contacts an electrical contact such as a coiled compression spring located within the laser housing (FIG. 1, 120) that is originally used to electrically couple the laser device assembly (Fig. 2, 210) to a power source.

Like the laser housing (FIG. 1, 120), the battery housing (320) may also include electrical contacts for electrically coupling the battery housing (320) to a power source such as batteries (340A, 340B). The batteries (220A, 220B) originally used in the laser device (100) may be, for example, two AAA batteries. However, because the battery housing (320) restricts the radial space within the laser housing (FIG. 1, 120) when installed therein, in one embodiment, two AAAA batteries (340A, 340B) may be used. In this embodiment, the battery housing (320) may be designed to securely hold both AAAA batteries (340A, 340B).

When installed, the battery housing (320) provides electrical contact between the negative terminal of the lower battery (340B) and the coiled compression spring within the laser device via the electrically conductive end (330) of the battery housing (320). The battery housing (320) may also provide electrical contact between the negative terminal of the lower battery (340B) and the contactor spring of the emission indicator assembly (350) or other element as will be discussed in more detail below.

### Emission Indicator Assembly

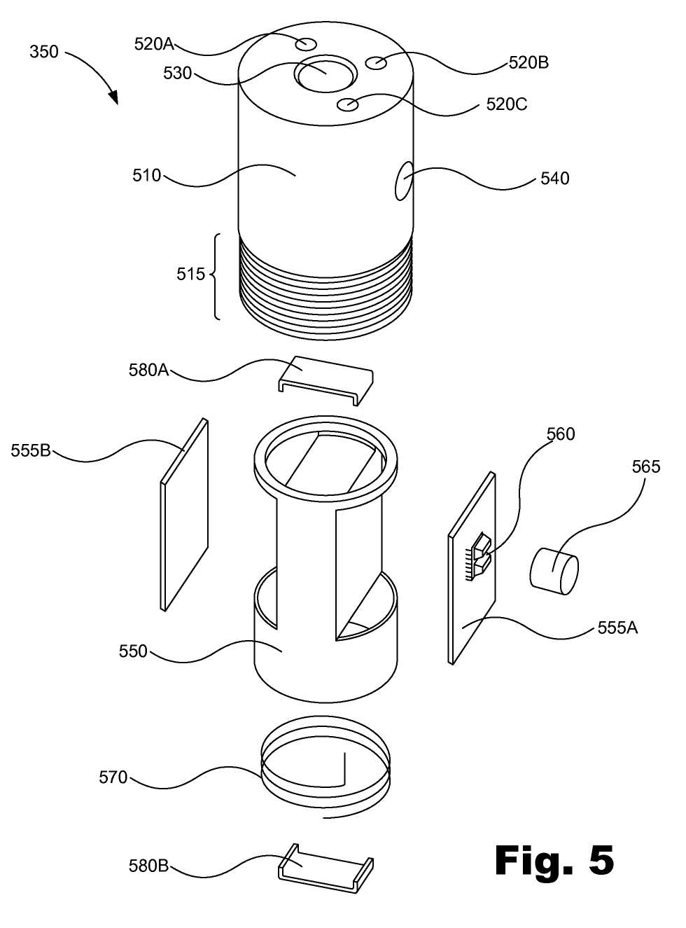

FIG. 5 is an exploded view of an emission indicator assembly (350) according to an embodiment of the present exemplary system and method. The emission indicator assembly (350) may include a housing (510) for enclosing the various elements of the emission indicator assembly (350). In one embodiment, the housing (510) may be made from any electrically conductive material. The housing (510) may include threads (515) formed on the lower portion of the housing (510), and may be engineered to mate with the internal threads (Fig. 3, 310) of the non-compliant laser device (FIG. 3, 100). The threads (515) of the emission indicator assembly housing (510) thus provide means for retaining the battery housing (FIG. 3, 320) and batteries (340A, 340B) within the non-compliant laser device (FIG. 3, 100) much like the battery cover (FIG. 1, 140) of the non-compliant laser device (FIG. 3, 100) would.

Further, the housing (510) of the emission indicator assembly (350) may include a number of fastening points (520A, 520B, 520C) for fastening other elements to the non-threaded end of the emission indicator assembly (350). In one exemplary embodiment, the fastening points (520A, 520B, 520C) may include internal threads used to receive screws. However, other fasteners may be utilized in coupling other elements to the emission indicator assembly (350) including, but not limited to, rivets, pins, screws, or bolts. As will be discussed below, the fastening points (520A, 520B, 520C) may be configured to receive a number of screws included in the key control/remote interlock assembly (FIG. 3, 360).

The housing (510) of the emission indicator assembly (350) may also include an electrical contact port (530) for electrically coupling other elements to the non-threaded end of the emission indicator assembly (350) such as, for example, the key control/remote interlock assembly (FIG. 3, 360). Similar to the fastening points (520A, 520B, 520C), in one exemplary embodiment, the electrical contact port (530) may be configured to receive an electrical contact of the key control/remote interlock assembly (FIG. 3, 360).

Finally, the housing (510) may include an aperture (540) in a portion thereof. In one exemplary embodiment, the aperture (540) may be configured to receive a Light Emitting Diode (LED) assembly (560) as will be discussed in more detail below. The aperture (540) may be open to the outer wall of the housing (510), or may further include a window or other transparent or translucent covering to protect the LED assembly (560).

The emission indicator assembly (350) may further include a printed circuit board (PCB) mount (550). In one embodiment, the PCB mount (550) may be made of an electrically non-conductive material and may serve to insulate the exterior of the battery housing (FIGS. 3 and 4, 320) from the housing (510) of the emission indicator assembly (350). In one embodiment, the PCB mount (550) may be of a general cylindrical shape in order to fit within the housing (510) of the emission indicator assembly (350). The PCB mount (550) may further include a number of cavities located on portions of the sides of the PCB mount (550). A number of printed circuit boards (555A, 555B) may be retained within the cavities, and supported by the PCB mount (550).

The printed circuit boards (555A, 555B) may provide the emission indicator assembly (350) with the circuitry necessary to cause the emission indicator assembly (350) to function according to its intended purpose. As indicated above, the emission indicator assembly (350) is used to indicate to a user that the laser device is on. Therefore, in one embodiment, the printed circuit boards (555A, 555B) may include circuitry required to turn on a light emitting diode (LED) assembly (560) electrically connected to the printed circuit boards (555A, 555B). In one embodiment, a single printed circuit board may be used.

A lens (565) may further be in optical alignment with the LED assembly (560) so that light emitted from the LED assembly (560) may be focused. In one embodiment, the lens (565) may function as a conduit to allow light to escape the housing (510) while ensuring that no contaminants enter the housing via the aperture (540). In another embodiment, the lens may also serve to focus light emitted from the LED assembly (560) in a manner that is more readily ascertainable by a user. The lens (565) may assist a user in better identifying the activation of the LED assembly (560), and, in turn, more readily recognize the actuation of the laser device (FIG. 3, 100). The LED assembly (560) and lens (565), in one exemplary embodiment, along with the PCB mount (550) may be inserted into the housing (510) of the emission indicator assembly (350) such that the LED assembly (560) and lens (565) align with the aperture (540) of the housing (510). Thus, the light emitted from the LED assembly (560) may be readily visible through the aperture (540). Finally, any number of LED assemblies and aperture (540) pairs may be provided in the emission indicator assembly (350).

The next elements included in the emission indicator assembly (350) may be an upper contact (580A) and a lower contact (580B). Generally, the upper and lower contacts (580A, 580B) serve to electrically couple various elements of the laser device (FIG. 3, 100). Specifically, the upper and lower contacts (580A, 580B) serve to electrically couple printed circuit boards (555A, 555B). Further, the upper contact (580A) serves to electrically couple the key control/remote interlock assembly (360) and the emission indicator assembly (350) as will be discussed in more detail below. Finally, the lower contact (580B) serves to electrically couple the emission indicator assembly (350) to the positive terminal of the upper battery (FIGS. 3-4, 340A).

Finally, the emission indicator assembly (350) may be provided with a battery housing contactor spring (570). The battery housing contactor spring (570) serves to electrically couple printed circuit board (555A) and the battery housing (FIGS. 3 and 4, 320). This provides for electrical connection from the negative terminal of the batteries (340A, 340B), through the battery housing (FIGS. 3 and 4, 320), and to the printed circuit board (555A). Thus, sufficient electromotive force may be provided to the LED assembly (560) through this arrangement.

### Key Control/Remote Interlock Assembly

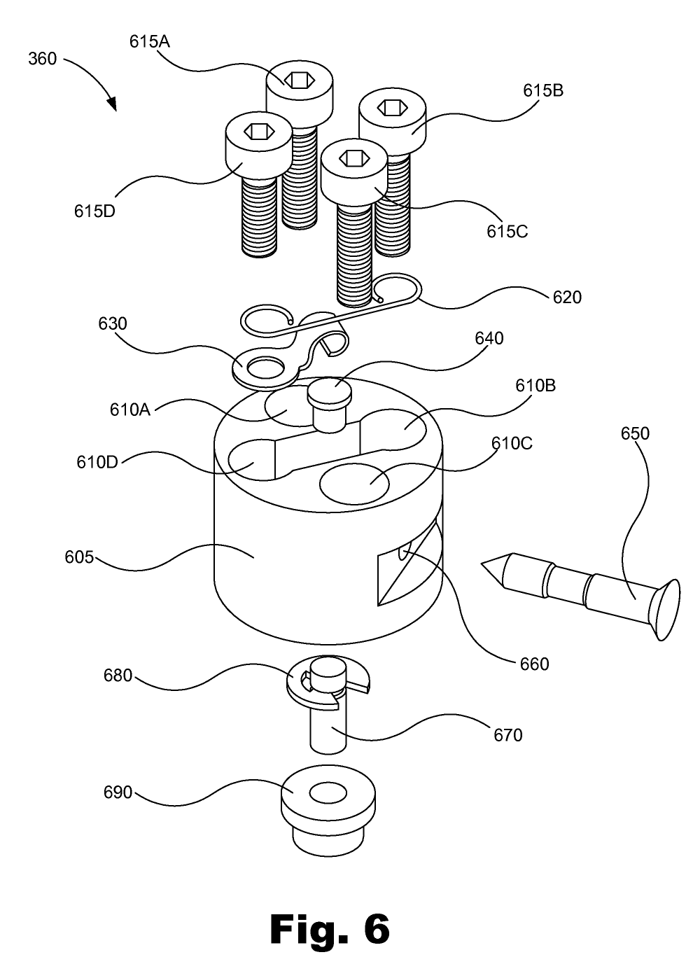

FIG. 6 is an exploded view of a key control/remote interlock assembly (360) according to an embodiment of the present exemplary system and method. Like the battery housing (FIG. 4, 320) and emission indicator assembly (FIG. 5, 350), the key control/remote interlock assembly (360) may include several elements that serve to complete the circuit of the overall laser device (FIG. 3, 100). To begin, the key control/remote interlock assembly (360) may include a support base (605). The support base (605) is used to connect and retain the various conductive and non-conductive elements of the key control/remote interlock assembly (360). The support base (605) may be of a general cylindrical shape, and may be made of an electrically non-conductive material.

The support base (605) may include a number of apertures (610A, 610B, 610C, 610D) for receiving and retaining a number of elements as will be discussed in more detail below. The apertures (610A, 610B, 610C, 610D) may be formed with regard to the vertical axis of the support base (605), and may run the entire length of the support base (605). In one embodiment, aperture (610D) may not run the entire length of the support base (605) as will be discussed in more detail below. In connection with the support base (605), the key control/remote interlock assembly (360) may include several fasteners for mechanically and/or electrically coupling the elements of the laser device (FIG. 3, 100) together. In one embodiment, the fasteners are screws (615A, 615B, 615C, 615D). However, the fasteners may be any element that mechanically couples one element to another including, but not limited to, rivets, pins, screws, or bolts.

The apertures (610A, 610B, 610C, 610D) in the support base (605) may be configured to retain the screws (615A, 615B, 615C, 615D) respectively, within the support base (605) such that once a screw (615A, 615B, 615C, 615D) is threaded through an aperture (610A, 610B, 610C, 610D), the screw may mechanically and/or electrically couple the key control/remote interlock assembly (360) to the emission indicator assembly (FIG. 5, 350). Further, the screws may serve to mechanically and/or electrically couple various elements of the key control/remote interlock assembly (360). However, as mentioned above, in one embodiment, screw (615D) may be shorter than screws (615A, 615B, 615C) and may be further configured to thread through aperture (610D) to the length of aperture (610D). In other words, aperture (610D) and screw (615D) may be configured such that aperture (610D) does not open to the bottom of the support base (605), and screw (615D) may be configured to be threaded to the length of aperture (610D). Therefore, in this embodiment, screw (615D) does not exit the support base (605) and does not mechanically or electrically couple to the emission indicator assembly (FIG. 5, 350).

In one exemplary embodiment, screws (615A, 615C) may serve no electrical coupling function, but may, instead, be utilized to mechanically couple the key control/remote interlock assembly (360) to the emission indicator assembly (FIG. 5, 350). More specifically, screws (615A, 615C) may be threaded through apertures (610A, 610C), and into fastening points (520A, 520C) of the emission indicator assembly (FIG. 5, 350). Thus, in this manner, the key control/remote interlock assembly (360) is mechanically coupled to the emission indicator assembly (FIG. 5, 350).

Further, screw (615D) may also serve no direct electrical coupling function between the key control/remote interlock assembly (360) and the emission indicator assembly (FIG. 5, 350), but may, instead, be utilized to assist in providing electrical continuity between contact points within the key control/remote interlock assembly (360) as will be discussed in more detail below. Further, screw (615B) may further serve to mechanically and electrically couple the key control/remote interlock assembly (360) to the emission indicator assembly (FIG. 5, 350). Like the other screws (615A, 615C), screw (615B) may be threaded through aperture (610B), and into fastening point (520B) of the emission indicator assembly (FIG. 5, 350). Thus, in this manner, screw (615B) may also serve to mechanically couple the key control/remote interlock assembly (360) to the emission indicator assembly (FIG. 5, 350). Finally, screw (615B) may also serve to provide electrical continuity between the electrically conductive key control/remote interlock assembly (FIG. 3, 360) and one end of the shunt wire (620).

The key control/remote interlock assembly (360) may also include a shunt wire (620). As mentioned above, the key control/remote interlock assembly (360) may include a remote interlock system. The remote interlock system is a safety device used to remotely permit activation or deactivation of the laser device (FIG. 3, 100) with an external safety interlock switch. Thus, the laser device (FIG. 3, 100) may be used as a handheld, portable device, or as a stationary device which may be remotely activated or deactivated. If the laser device (FIG. 3, 100) is to be used as a handheld, portable device, the shunt wire (620) should be included within the circuitry of the key control/remote interlock assembly (360). In one embodiment, the shunt wire (620) may electrically couple screw (615B) to screw (615D) thus providing electrical continuity between the remote interlock contact points. If the user of the laser device (FIG. 3, 100) wishes to prevent the activation of the laser device (FIG. 3, 100) remotely with, for example, an external switch for safety purposes, then the key control/remote interlock assembly (360) may be configured such that the user may remove the shunt wire (620), and electrically couple the key control/remote interlock assembly (360) to an external switch via screws (615B, 615D).

Still in reference to FIG. 6, the key control/remote interlock assembly (360) may further include a spring contact (630), an upper contact (640), a key (650), a lower contact (670), and an E-ring (680). These elements may be made from an electrically conductive material. The key control/remote interlock assembly (360) may further include a lower contact guide (690). The lower contact guide may be made from an electrically non-conductive material.

First, screw (615D) may be in electrical contact with a spring contact (630). The spring contact (630) may include a circular portion including an aperture through which screw (615D) may be inserted. The spring contact (630) may also include a spring portion that is biased to apply force to the top of the upper contact (640).

In order to place the laser device (FIG. 3, 100) in an operable state, the key (650) is inserted into a key aperture (660). In one exemplary embodiment, the key aperture (660) runs perpendicular with respect to the vertical axis of the upper contact (640). Once the key (650) is inserted into the key aperture (660), the upper contact (640), through the biased force of the spring contact (630), is force toward and remains in electrical contact with the key (650). The key (650), when inserted in the key aperture (660), also becomes to be in electrical contact with the lower contact (670).

However, when the key (650) is not inserted into the key aperture (660), the laser device (FIG. 3, 100) is not operable. In other words, when the key (650) is not inserted into the key aperture (660), the upper and lower contacts (640, 670) are not in electrical contact. In one exemplary embodiment, the upper contact (640) is configured with a top retaining portion that prevents it from being forced further into the support base (605) by the spring contact (630) and coming in electrical contact with the lower contact (670). Further, the lower contact (670) is also retained in position by the E-ring (680) as will be discussed below. Thus, the key (650) acts as another safety device. If a user of the laser device (FIG. 3, 100) does not insert the key (650) into the key aperture (660), the overall electrical circuit of the laser device (FIG. 3, 100) will be open, and the laser device (FIG. 3, 100) will not operate. Therefore, if either the key (650) or the shunt wire (620) is removed from the key control/remote interlock assembly (360), electrical continuity between the lower contact (670) and screw (615B) would be interrupted. This, in turn, would interrupt electrical continuity between the batteries (340A, 340B) and the laser device assembly (FIG. 2, 210), and the laser device (FIG. 3, 100) will not operate.

The lower contact (670) of the key control/remote interlock assembly (360) is retained within the support base (605) by the lower contact guide (690) and the E-ring (680). The E-ring (680) ensures that the lower contact (670) does not slip through the lower contact guide (690) or further into the support base (605). The lower contact guide (690) may be configured to securely fit the electrical contact port (FIG. 5, 530) of the emission indicator assembly (350). In this configuration, the lower contact guide (690) would then align the lower contact (670) such that the lower contact (670) would be brought into electrical contact with the upper contact (FIG. 5, 580A) of the emission indicator assembly (350). Thus, the lower contact (670) and the electrical contact port (FIG. 5, 530) serve to electrically couple the key control/remote interlock assembly (360) and the electrical contact port (FIG. 5, 530).

### Control Circuitry of the Now Compliant Laser Device

As discussed above in connection with FIG. 2, in the basic laser device, (Figs. 1 and 2, 100) current flows from the batteries (220A, 220B) through the laser device assembly (FIG. 2, 210) whenever the switch (130) is actuated. After the battery housing (FIG. 4, 320), emission indicator assembly (FIG. 5, 350), and key control/remote interlock assembly (FIG. 6, 360) are installed in a previously non-compliant laser device (FIG. 3, 100), the function of the laser device appears to a user to be the same. However, the control circuitry within the emission indicator assembly (FIG. 5, 350) modifies the current flow through the laser device in order to provide the required emission indicator function as well as in order to provide for the key (650) and shunt wire (620) to function as safety devices.

The following description regarding the control circuitry and current flow of a non-compliant laser device (FIG. 3, 100) incorporating the battery housing (FIG. 4, 320), emission indicator assembly (FIG. 5, 350), and key control/remote interlock assembly (FIG. 6, 360) assumes that both the key (650) and shunt wire (620) are in place within the key control/remote interlock assembly (FIG. 6, 360).

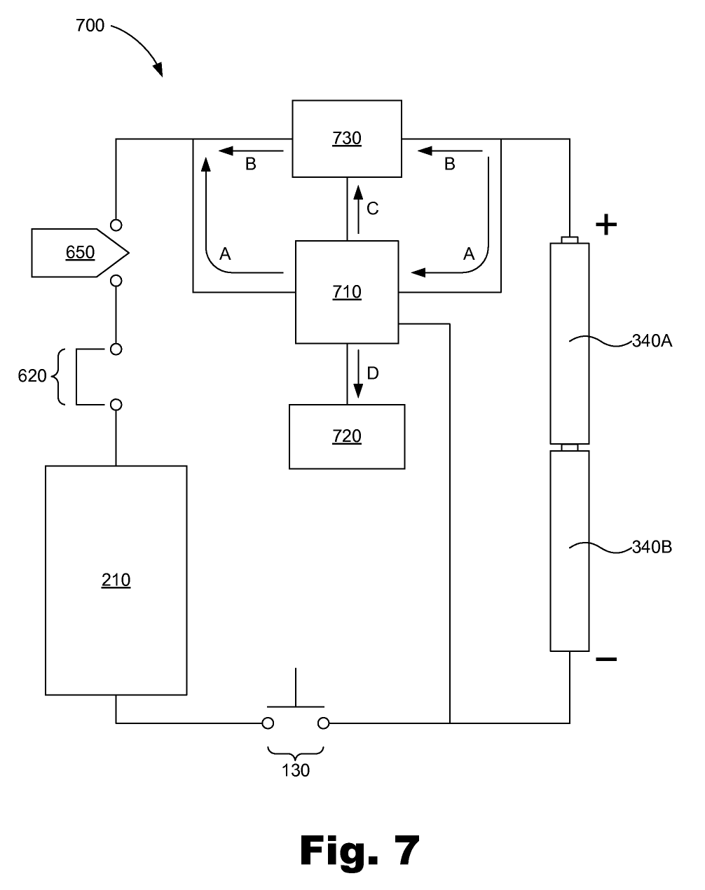

FIG. 7 is a diagram of the control circuitry of the laser device incorporating the elements described herein to render the device compliant according to an embodiment of the present exemplary system and method. The control circuitry of the now-compliant laser device (700) may include a switch (130), a power source such as batteries (340A, 340B), a current sensing circuit (710), an LED circuit (720), a high current switch (730), a key (650), a shunt wire (620), and a laser device assembly (210). The switch (130), batteries (340A, 340B), key (650), shunt wire (620), and laser device assembly (210) have been described above.

To begin, a user may actuate the switch (130). Upon doing so, an amount of current flows through the current sensing circuit (710) via current path A. In one embodiment, the amount of current that is provided to flow through the current sensing circuit (710) may be a minimal amount of current. The current sensing circuit (710) then generates two signals. The first signal may be directed to the LED circuit (720) via current path D. Current flowing via current path D to the LED circuit (720) turns on the LED/LED's located in the emission indicator assembly (FIG. 5, 350). The second signal may be directed to the high current switch (730) via current path C. Current flowing via current path C to the high current switch (730) turns on the high current switch (730).

When the high current switch (730) is on, ample operating current is allowed to flow through the laser device assembly (210) via current path B. Further, when the high current switch (730) is on, the high current switch (730) causes current to shunt across or bypass the current sensing circuit (710). This bypass reduces the current flowing through path A to zero, and effectively disables the current sensing circuit (710). This, in turn, also eliminates the current flowing through current path C. Because no current is flowing through current path C, the high current switch (730), after a period of time, turns off. This then eliminates the shunting effect across the current sensing circuit (710). At this point, electrical current again flows through the current sensing circuit via current path A. The process described above then starts over.

Except for very brief periods of time when the high current switch is off, ample current is allowed to flow through the laser device assembly (210) via current path B, and the LED circuit (720) located in the emission indicator assembly (FIG. 5, 350) is on whenever the switch (130) of the laser device is actuated. The frequency of this repeating process can be controlled within a range by component values. However, in one exemplary embodiment, the frequency of this process may be set higher than 100 Hz so that the brief period when the emission indicator assembly (FIG. 5, 350) and laser device assembly (210) are off is not detectable by the unaided eye.

### Assembly and Sale of Compliant Elements

When assembled, the battery housing (FIG. 4, 320), emission indicator assembly (FIG. 5, 350), and key control/remote interlock assembly (FIG. 6, 360) make the non-compliant laser device (FIG. 3, 100) into a compliant laser device. In commerce, according to one exemplary embodiment, the battery housing (FIG. 4, 320), emission indicator assembly (FIG. 5, 350), and key control/remote interlock assembly (FIG. 6, 360) may be included in a single kit for sale to owners of non-compliant laser devices (FIG. 3, 100). In this embodiment, the emission indicator assembly (FIG. 5, 350) and key control/remote interlock assembly (FIG. 6, 360) may be sold as one single device. In another exemplary embodiment, the emission indicator assembly (FIG. 5, 350) and key control/remote interlock assembly (FIG. 6, 360) may be coupled together by the manufacturer prior to the sale of the kit. In another embodiment, the emission indicator assembly (FIG. 5, 350) and key control/remote interlock assembly (FIG. 6, 360) may be sold as separate elements within the kit. In this embodiment, the user may be provided with instructions on how to electrically and mechanically couple the emission indicator assembly (FIG. 5, 350) and key control/remote interlock assembly (FIG. 6, 360).

In yet another embodiment, the battery housing (FIG. 4, 320), emission indicator assembly (FIG. 5, 350), and key control/remote interlock assembly (FIG. 6, 360) may each be sold separately. This may be advantageous for those laser devices that do not require all of these elements due to the parameters of that particular laser device (e.g. a different type, class, wavelength, and power output), or due to the pre-inclusion of one or more of these elements in the non-compliant laser devices (FIG. 3, 100).

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. An assembly for use with a non-compliant laser device comprising the combination of:
an emission indicator assembly configured to indicate the actuation of the laser device;
a key control assembly configured to selectively provide electrical continuity throughout circuitry of laser device; and
a remote interlock assembly configured to selectively provide for activation of the device from a remote location and provide electrical continuity throughout the circuitry of the laser device.

2. The assembly of claim 1, further comprising a battery housing configured to house a number of batteries.

3. The assembly of claim 1, wherein the key control assembly and remote interlock assembly are configured to be integrated in a single assembly.

4. The assembly of claim 3, wherein the key control/remote interlock assembly and emission indicator assembly are coupled prior to the sale of the assembly.

5. The assembly of claim 1, wherein the emission indicator assembly comprises:
an LED assembly configured to turn on when the non-compliant laser device is actuated;
a lower contact for electrically coupling the emission indicator assembly to a power source;
an upper contact for electrically coupling the emission indicator assembly to the key control assembly and remote interlock assembly.

6. The assembly of claim 1, wherein the emission indicator assembly further comprises:
a current sensing circuit for sensing an electrical current through the electrical circuitry of the emission indicator assembly and providing current to a laser device assembly of the non-compliant laser device;
an LED circuit including an LED assembly electrically coupled to the current sensing circuit, wherein the LED circuit activates the LED assembly when an electrical current is sensed by the current sensing circuit; and
a high current switch electrically coupled to the current sensing circuit, wherein the high current switch is activated when an electrical current is sensed by the current sensing circuit and wherein the high current switch provides for a current path for current to bypass the current sensing circuit and provide current to the laser device assembly.

7. The assembly of claim 1, wherein the key control assembly comprises:
a lower contact for electrically coupling the key control assembly to the emission indicator assembly;
an upper contact disposed juxtaposition to the lower contact; and
a key removably disposed, and electrically coupled to the lower contact and upper contact.

8. The assembly of claim 1, wherein the remote interlock assembly comprises:
a first remote interlock contact point;
a second remote interlock contact point; and
a shunt wire removably disposed, and electrically coupled between the first and second remote interlock contact points.

9. A compliant laser device comprising:
a non-compliant laser device;
an emission indicator assembly electrically coupled to the non-compliant laser device and configured to indicate the actuation of the non-compliant laser device;
a key control assembly electrically coupled to the emission indicator assembly and configured to selectively provide electrical continuity throughout the circuitry of non-compliant laser device; and
a remote interlock assembly electrically coupled to the key control assembly and configured to selectively provide for activation of the non-compliant laser device from a remote location and provide electrical continuity throughout the circuitry of non-compliant laser device.

10. The compliant laser device of claim 9, further comprising a battery housing configured to house a number of batteries.

11. The compliant laser device of claim 9, wherein the key control assembly and remote interlock assembly are configured to be integrated in a single assembly.

12. The compliant laser device of claim 11, wherein the key control/remote interlock assembly and emission indicator assembly are removably coupled.

13. The compliant laser device of claim 9, wherein the emission indicator assembly comprises:
an LED assembly configured to turn on when the non-compliant laser device is actuated;
a lower contact for electrically coupling the emission indicator assembly to a power source;
an upper contact for electrically coupling the emission indicator assembly to the key control assembly and remote interlock assembly.

14. The compliant laser device of claim 9, wherein the emission indicator assembly further comprises:
a current sensing circuit for sensing an electrical current through the electrical circuitry of the emission indicator assembly and providing current to a laser device assembly of the non-compliant laser device;
an LED circuit including an LED assembly electrically coupled to the current sensing circuit, wherein the LED circuit activates the LED assembly when an electrical current is sensed by the current sensing circuit; and
a high current switch electrically coupled to the current sensing circuit, wherein the high current switch is activated when an electrical current is sensed by the current sensing circuit and wherein the high current switch provides for a current path for current to bypass the current sensing circuit and provide current to the laser device assembly.

15. The compliant laser device of claim 9, wherein the key control assembly comprises:
a lower contact for electrically coupling the key control assembly to the emission indicator assembly;
an upper contact disposed juxtaposition to the lower contact; and
a key removably disposed and electrically coupled to the lower contact and upper contact.

16. The compliant laser device of claim 9, wherein the remote interlock assembly comprises:
a first remote interlock contact point;
a second remote interlock contact point; and
a shunt wire removably disposed, and electrically coupled between the first and second remote interlock contact points.

17. An assembly for non-compliant laser devices comprising the combination of:
an emission indicator assembly configured to selectively indicate the actuation of the non-compliant laser device.

18. The assembly of claim 17, further comprising a key control assembly configured to selectively provide electrical continuity throughout the circuitry of the non-compliant laser device.

19. The assembly of claim 17, further comprising a remote interlock assembly configured to selectively prevent or permit local activation of the non-compliant laser device from a remote location by denying or providing electrical continuity throughout the circuitry of non-compliant laser device.

20. The assembly of claim 17, further comprising a battery housing configured to house a number of batteries.

21. The assembly of claim 19, wherein the key control assembly and remote interlock assembly are configured to be integrated in a single assembly.

22. A control circuit for a laser device comprising:
a switch configured to close the control circuit upon activation of the switch;
a power source configured to provide current through the circuit upon activation of the switch;
a current sensing circuit electrically coupled to the power source, and configured to sense a current from the power source via a first current path, and generate a number of signals to a number of electrical components;
a high current switch configured to activate upon receiving a signal from the current sensing circuit via a second current path, and shunt current across the current sensing circuit via a third current path.

23. The control circuit of claim 22, further comprising a light emitting diode (LED) circuit comprising a number of light emitting diodes, and configured to receive a signal from the current sensing circuit via a fourth current path, and activate the light emitting diodes upon receipt of the signal from the current sensing circuit.

24. The control circuit of claim 22, wherein, when the high current switch shunts current across the current sensing circuit, the current flowing through the first current path is reduced to zero, and the current sensing circuit is deactivated.

25. The control circuit of claim 24, wherein, when the current sensing circuit is deactivated, the current flowing through the third current path is reduced to zero, and the high current switch is deactivated.

26. The control circuit of claim 24, wherein, when the current sensing circuit is deactivated, the current flowing through the fourth current path is reduced to zero, and the light emitting diode (LED) circuit is deactivated.

27. The control circuit of claim 25, wherein the activation of the high current switch, deactivation of the current sensing circuit, and deactivation of the high current switch is performed at a predefined frequency while the switch is activated.

28. The control circuit of claim 27, wherein the predefined frequency is at least approximately 100 Hz.

29. The control circuit of claim 27, wherein the predefined frequency is an effective frequency sufficient to cause the period when the high current switch is deactivated to not be detectable by a user's unaided eye.

30. The control circuit of claim 22, further comprising a key configured to selectively close the control circuit.

31. The control circuit of claim 22, further comprising a shunt wire configured to selectively close the control circuit and removably coupled to the control circuit to selectively activate the laser device via an external switch.

32. A method of modifying current flow through a control circuit of a laser device, comprising:
activating a switch configured to close the control circuit upon activation of the switch;
providing a power source configured to provide current through the circuit upon activation of the switch;
providing a current sensing circuit configured to sense a current provided by the power source via a first current path;
generating a number of signals to a number of electrical components upon sensing current through the first current path;
receiving a signal at a high current switch from the current sensing circuit via a second current path; and
shunting current across the current sensing circuit via a third current path.

33. The method of claim 32, further comprising:
providing a light emitting diode (LED) circuit comprising a number of light emitting diodes;
receiving a signal at the LED circuit from the current sensing circuit via a fourth current path; and
activating the light emitting diodes upon receipt of the signal from the current sensing circuit.

34. The method of claim 33, wherein, when the current is shunted across the current sensing circuit, the current flowing through the first current path is reduced to zero, and the current sensing circuit is deactivated.

35. The method of claim 34, wherein, when the current sensing circuit is deactivated, the current flowing through the third current path is reduced to zero, and the high current switch is deactivated.

36. The method of claim 34, wherein, when the current sensing circuit is deactivated, the current flowing through the fourth current path is reduced to zero, and the light emitting diode (LED) circuit is deactivated.

37. The method of claim 35, wherein the activation of the high current switch, deactivation of the current sensing circuit, and deactivation of the high current switch is performed at a predefined frequency while the switch is activated.

38. The method of claim 37, wherein the predefined frequency is at least approximately 100 Hz.

39. The method of claim 37, wherein the predefined frequency is an effective frequency sufficient to cause the period when the high current switch is deactivated to not be detectable by a user's unaided eye.

40. The method of claim 32, further comprising providing a key configured to selectively close the control circuit.

41. The method of claim 32, further comprising providing a shunt wire configured to selectively close the control circuit and removably coupled to the control circuit to selectively activate the laser device via an external switch.
